(19) United States
(12) Patent Application Publication
(10) Pub. No.: US 2003/0182551 A1
(43) Pub. Date: Sep. 25, 2003

(54) Method for a single sign-on

(76) Inventors: Christopher J. Frantz, Houston, TX (US); E. David Neufeld, Magnolia, TX (US)

Correspondence Address: Michael G. Fletcher, Fletcher, Yoder & Van Someren, P.O. Box 692289, Houston, TX, 77269-2289, US

(21) Appl. No.: 10/105,145

(22) Filed: Mar. 25, 2002

(51) Int. Cl. H04L 9/00

(52) U.S. Cl. 713/170; 713/201

(57) ABSTRACT

A technique is provided for authenticating a client for multiple network devices and services using a single sign-on mechanism. The present technique stores client credentials at each of the multiple network devices and services, which generate and transform an authentication challenge (e.g., a random number) using an appropriate one of the client credentials stored thereon. At the client-side, the single sign-on mechanism stores client credentials entered during a first authentication process. Subsequent authentication processes simply retrieve the client credentials stored by the single sign-on mechanism during the first authentication process. The technique then independently transforms the authentication challenge received at the client-side using the client credentials at the client-side. The technique then authenticates the client if the independent transformations produce an equivalent result. Alternatively, the single sign-on mechanism may retain an authentication token generated during the first authentication process. In either case, the present technique authenticates the client by retaining client credentials independently at both the client-side and server-side, thereby improving security and reducing or eliminating the need for data encryption during the authentication process.

### BACKGROUND OF THE INVENTION

1. Field of the Invention

The present technique relates generally to computer security systems and, more particularly, to user sign-on systems for network devices and services. The present technique provides a single sign-on mechanism for authenticating a client for multiple network devices and services.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In computer networks, a client may desire access to a plurality of network devices and services, such as information services, commercial retail and wholesale services, and various other services. The client typically signs-on to each individual network device or service independently as the client seeks access to the respective devices and services. Accordingly, the client transmits credentials (e.g., client identification and data used for authentication) over the network each time the client signs-on to an additional network device or service, thereby increasing the overall nuisance of connecting to and using these devices and services.

Accordingly, a single sign-on technique would be desirable for signing onto multiple network devices and services. It also would be advantageous to reduce or minimize the transmission of client credentials over the network during each sign-on process for the network devices and services. It also enhances the customer experience and makes the enterprise easier to manage.

### BRIEF DESCRIPTION OF THE DRAWINGS

Certain advantages of the invention may become apparent upon reading the following detailed description and upon reference to the drawings in which:

FIG. 1 is a block diagram illustrating an exemplary network in which the present technique may be practiced; and

FIG. 2 is a block diagram illustrating an exemplary single sign-on system of the present technique; and

FIGS. 3 and 4 are flow charts illustrating exemplary single sign-on processes of the present technique.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present technique provides a single sign-on system and method for authenticating a client for multiple network devices and services. The present technique stores client credentials at each of the multiple network devices and services, which generate and transform an authentication challenge (e.g., a random number) using an appropriate one of the client credentials stored thereon. At the client-side, the single sign-on mechanism stores client credentials entered during a first authentication process. Subsequent authentication processes for other devices on the network simply use the client credentials stored by the single sign-on mechanism during the first authentication process. The technique then independently transforms the authentication challenge received at the client-side using the client credentials at the client-side. The technique then authenticates the client if the independent transformations produce an equivalent or otherwise acceptable result. Alternatively, the single sign-on mechanism may retain an authentication token generated during the first authentication process. In either case, the present technique authenticates the client by retaining client credentials independently at both the client-side and server-side, thereby improving security and reducing or eliminating the need for data encryption during the authentication process.

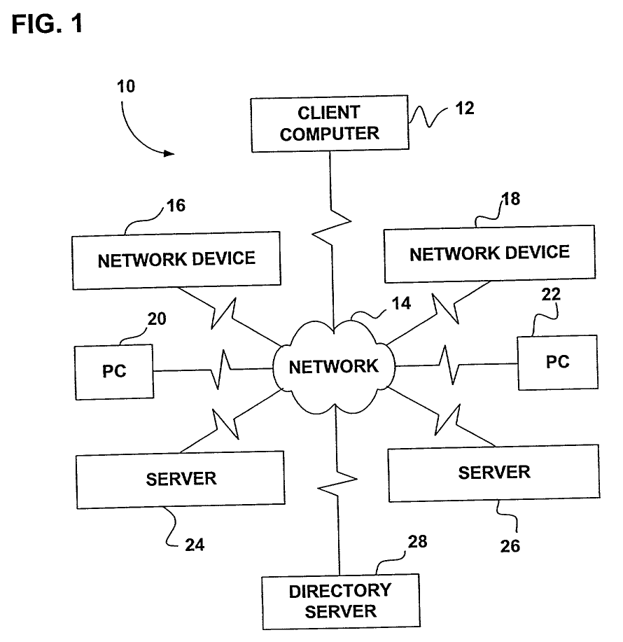

Turning now to the drawings and referring initially to FIG. 1, a block diagram of an exemplary system in which the present invention may be practiced is illustrated and designated using a reference numeral 10. As illustrated, the system comprises a client computer 12 communicatively coupled to a plurality of remote devices via a network 14. The network 14 may comprise a local area network (LAN), a wide area network (WAN) such as the Internet, or any suitable network arrangement. Accordingly, the network 14 may comprise a variety of computers and network devices, such as network devices 16 and 18, personal computers 20 and 22, servers 24 and 26 (e.g., a headless server), and a directory server 28. Using the appropriate communication protocols, the client computer 12 may communicate with any of the foregoing network devices, computers, and servers via the network 14.

The client computer 12 may embody any desired stationary or mobile computing device, such as a desktop computer, a laptop computer, a personal digital assistant, a workstation, a server, or any other processor-based device. Accordingly, the client computer 12 may comprise a variety of software and hardware, such as an operating system, application programs, circuitry, a processor, random access memory (RAM), read only memory (ROM), a hard disk drive, CD/DVD drives, a floppy disk drive, audio/video devices (e.g., a monitor), input/output devices (e.g., a keyboard, a mouse, etc.), and/or various other components.

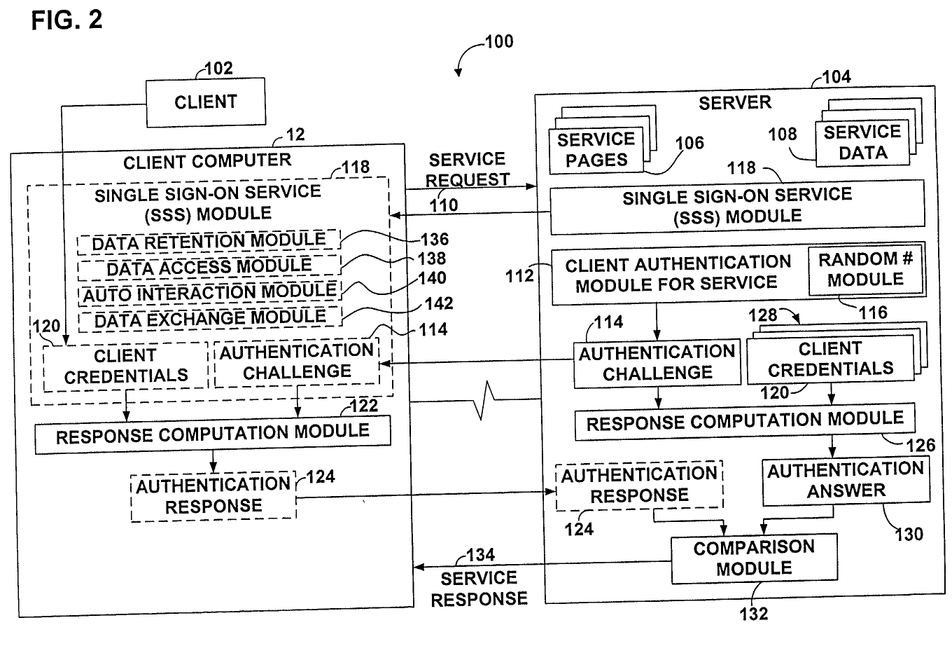

FIG. 2 is a block diagram illustrating an exemplary single sign-on system 100 for use in a network, such as network 14 illustrated in FIG. 1. As illustrated, the client 102 interacts with the client computer 12 to gain access to and to interact with a remote server 104 via the network 14. For example, the client 102 may seek access to a plurality of service pages 106 and service data 108 disposed on the server 104 by browsing to the services disposed on the server 104 via a web interface, such as Netscape, Microsoft Internet Explorer, or America Online. Accordingly, as the client 102 searches or browses the network, the client computer 12 may transmit a service request 110 for access to the service pages 106 and service data 108.

The server 104 processes the service request 110 by initializing a client authentication module 112, which generates an authentication challenge 114 to the service request 110 and transmits the challenge 114 to the client computer 12. For example, the client authentication module 112 may comprise a random number module 116, which obtains or generates a unique, non-predictable, and non-repeating number for generating the authentication challenge 114. Accordingly, the authentication challenge 114 may embody a random number with a length of B bits, such as 128 to 512 bits. For additional security, the system 100 also may control the timing of the authentication challenges 114. For example, the server 104 may limit the number N of authentication challenges 114 to a given client 102 over a period of time T1 (e.g., five authentication challenges 114 over a 300 second time interval). The server 104 also may invalidate the authentication challenges 114 after a period of time T2, such as 60 seconds.

The server 104 and/or the client 12 also may have a single sign-on service (SSS) module 118 to facilitate multiple network sign-on authentications via a single sign-on routine by the client 102. A remote server, such as the directory server 28, also may have the SSS module 118 or another suitable single sign-on service module. The SSS module 118 may embody a Java applet, VBScript, or any other suitable executable format. As illustrated in FIG. 2, and discussed in further detail below, the SSS module 118 may comprise a variety of modules to facilitate a IF single sign-on for multiple devices or services. For example, the SSS module 118 comprises a data retention module 136, the data access module 138, an auto interaction module 140, and a data exchange module 142. The data retention and access modules 136 and 138 are provided for locally storing and accessing client credentials and other authentication data derived from a first authentication routine. For example, the data retention module 136 may store client credentials in Web browser cache, on a floppy disk, on the hard drive, in RAM, or in any suitable storage location, or in the data memory area of an applet running inside the web browser. The auto interaction module 140 is provided for interacting with a client authentication system or challenge, such as the authentication challenge 114. For example, the auto interaction module 140 may notify the SSS module 118 of its presence and identify whether the requisite authentication data is stored by the SSS module 118. The data exchange module 142 is provided for exchanging authentication data obtained or needed by the authentication system or challenge, such as the authentication challenge 114. For example, the data exchange module 142 may provide the client credentials 120 automatically to the client authentication system or challenge at the client-side.

In response to the authentication challenge 114, the system 100 evaluates whether the SSS module 118 is currently operating on the client computer 12 and/or the server 104. If the SSS module 118 is not operating, then the system 100 initializes and executes the SSS module 118. For example, the server 104 may transmit the SSS module 118 to the client computer 12 for execution on the client computer 12. The system 100 then prompts the client to enter client credentials 120, such as an identity and security data (e.g., a password). The SSS module 118 then stores the client credentials 120 entered by the client 102 for future sign-on routines for authenticating the client 102 for additional devices and services. If the SSS module 118 is already operating, then the system 100 simply retrieves the client credentials 120 stored from the previous sign-on routine rather than prompting the client 102 to enter the client credentials 120 again. Accordingly, the SSS module 118 facilitates a single sign-on for multiple devices and services.

The authentication challenge 114 and client credentials 120 are then passed to a response computation module 122, which generates an authentication response 124 based on the authentication challenge 114 and client credentials 120. For example, the response computation module 122 may transform the authentication challenge 114 (e.g., a random number of B bits) with the client credentials 120. Any suitable algorithm, such as an MD5 or SHA1 hash, may be used for the foregoing transformation performed by the response computation module 122. Again, if the SSS module 118 is already running and the client 102 previously entered the client credentials 120, then the SSS module 118 automatically passes the client credentials 120 to the response computation module 122 for transformation of the authentication challenge 114. In either case, the system 100 then transmits the authentication response 124 to the server 104 for validation.

The server 104 evaluates the authentication response 124 by performing the same transformation as described above. Accordingly, the server 104 has a response computation module 126 and a copy of the client credentials 120 (e.g., within a set of client credentials 128) for independent transformation of the authentication challenge 114 transmitted to the client computer 12 in response to the service request 110. Accordingly, the present technique avoids transmitting the client credentials 120 across the network 14, thereby improving security and reducing the need for data encryption. The present technique also may utilize another remote server, such as the directory server 28, to facilitate the authentication process. For example, the system 100 may use the directory server 28 to retain the client credentials 102 along with a plurality of other client credentials. Moreover, the directory server 28 may comprise the single sign-on service (SSS) module 118 and the response computation module 126. In any case, the system 100 evaluates the authentication response 124 independently from the client computer 12 by transforming the authentication challenge 114 with the appropriate one (i.e., the client credentials 120) of the set of client credentials 128.

If the number of client credentials 128 exceeds a critical number, then the system 100 may transmit client identification data to the server 104 along with the authentication response 124 to identify the client credentials 120 within the set 128. However, the system 100 does not transmit other security data, such as a client password. As described above, the present technique retains the client credentials independently at both the client-side and the server-side. Accordingly, the system 100 does not require data encryption for authentication transmissions between the client computer 12 and the server 104. However, as noted above, a client identifier may facilitate the retrieval of the appropriate client credentials at the server 104. After the system 100 accesses the client credentials 120, the response computation module 126 transforms the authentication challenge 114 with the client credentials 120 to generate an authentication answer 130. A comparison module 132 then compares the authentication response 124 against the authentication answer 130 to determine whether the client 102 has access rights to the services desired by the service request 110. If the authentication response 124 and the authentication answer 130 are identical or otherwise acceptable, then the system 100 authenticates the client 102. Otherwise, the system 100 does not authenticate the client 102 and the server 104 rejects the service request 110. In either case, the server 104 transmits a service response 134 to the client computer 12 to notify the client computer 12 of the server's decision to authenticate or reject the service request 110.

If the number of client credentials 128 is less than a critical number, then the response computation module 126 may proceed to transform the authentication challenge 114 with each one of the client credentials 128 until the comparison module 130 discovers a match between the authentication response 124 and the authentication answer 130. As discussed above, a client identifier may facilitate the retrieval of the appropriate client credentials at the server 104. However, if the server 104 has relatively low number of client credentials 128 (i.e., less than a critical number), then the system 100 may provide increased security by proceeding without a client identifier. If the comparison module 132 discovers a match between the authentication response 124 and one of the authentication answers 130, then the system 100 authenticates the client 102. Otherwise, the system 100 does not authenticate the client 102 and the server 104 rejects the service request 110. The server 104 then transmits the service response 134 to the client computer 12 to notify the client computer 12 of the server's decision to authenticate or reject the service request 110.

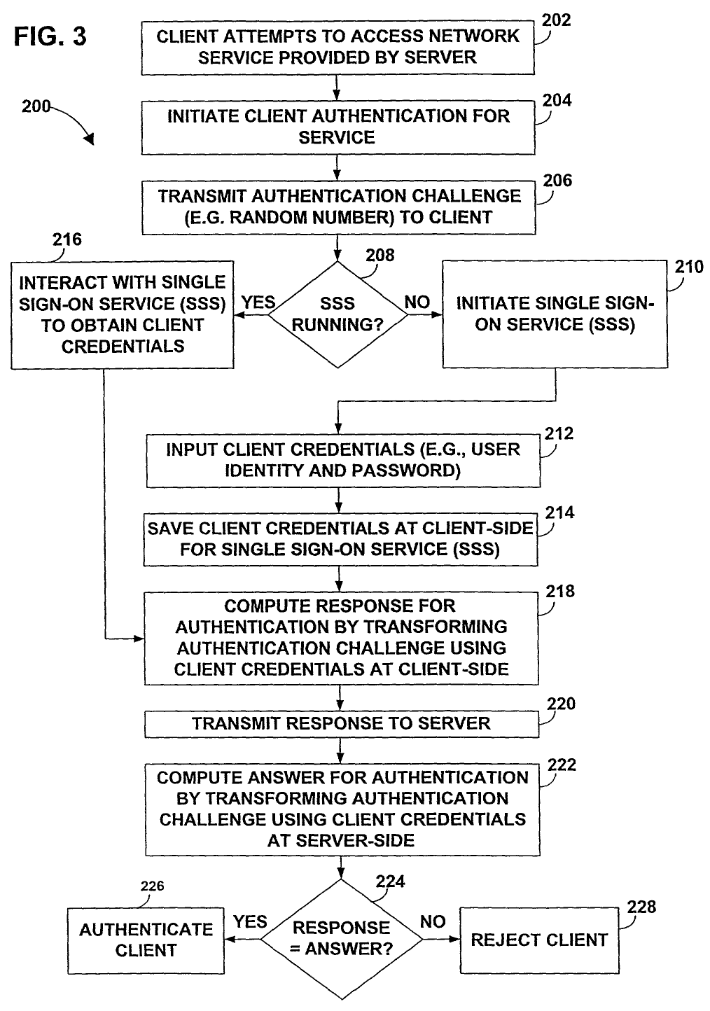

FIG. 3 is a flow chart illustrating an exemplary single sign-on process 200 of the present technique. As illustrated, the process 200 proceeds as the client locates and attempts to access a service provided by a server or other device on the network (block 202). For example, the client 102 may locate a desired intranet or extranet service by executing a script, by interacting with a file system or a user interface, or by searching/browsing the network via a Web browser to locate the desired information, products, or services. The process 200 then initiates a client authentication routine to authenticate the client 102 for the desired service (block 204). The server hosting the desired service then generates an authentication challenge, such as a random number of B bits, for independent transformation at both the server-side and the client-side. Alternatively, the server may initiate the client authentication routine and generate the authentication challenge for secure access to a desired service at another networked computer, server, or device, such as illustrated in FIG. 1. In any case, the process 200 transmits the authentication challenge to the client 102 (block 206). The process 200 then evaluates whether the single sign-on service (SSS), as described above, is currently operating on the desired one of the client and server sides (block 208).

If the query 208 determines that the single sign-on service is not currently operating, then the process 200 proceeds to initiate the single sign-on service (block 210). The process 200 then prompts the client 102 to input client credentials, such as client identification and security data (e.g., an identity and password), for responding to the authentication challenge (block 212). The single sign-on service then stores the client credentials at the client-side for use in subsequent sign-on routines for additional network devices and services (block 214). Preferably, these credentials are stored in a secure area in the client's memory so that other applications and users have no way to retrieve the information directly. Process 200 also may prompt the client 102 to provide an authentication token, or key, such as a smart card for a secure set of public and private keys. For example, the authentication token(s) or key(s) may be disposed on a smart card, which is accessible by the client computer, such as by inserting the card in a card reader at the client computer. The process 200 may then use the authentication token(s) or key(s) together with the client credentials to respond to the authentication challenge. Similarly, the process 200 may use any other additional security measures, such as local security devices, mobile security devices (e.g., smart card), or remote security devices, to increase the security of the single sign-on service.

Accordingly, if the query 208 determines that the single sign-on service is already operating, then the process 200 interacts with the single sign-on service to obtain the client credentials previously entered by the client 102 (block 216). For example, the single sign-on service may embody a JavaScript or VBScript routine that retains and provides the client credentials for automatic responding to authentication challenges from multiple network devices and services. The present technique also may use any other Web-based, or browser-based, code or routines to facilitate the single sign-on service.

In either case, the process 200 then proceeds to compute the response for authentication by transforming the authentication challenge using the client credentials at the client side (block 218). As described above, the process 200 may use any suitable transformation algorithm, such as an MD5 or SHA1 hash. The process 200 also may use both the client credentials and an authentication token/key (e.g., public and private keys, a smart card, etc.) to increase the security for the foregoing transformation. The process 200 then transmits the response computed at the client side to the server for evaluation (block 220). At the server side, the process 200 computes an answer for authentication by transforming the same authentication challenge transmitted to the client using the same client credentials stored at the server side (block 222). Again, the process 200 may use both the client credentials and a suitable authentication token to increase the security of the foregoing transformation. The process 200 then proceeds to grant or deny the authentication request from the client by comparing the response generated at the client side against the answer generated at the server side (block 224). It should be noted that the server will transmit some unpredictable data to seed the calculated response in order to avoid replaying a response to gain access to other devices, or the same device, at a future point in time. As described above, the process 200 may identify the appropriate client credentials at the server side by retrieving the client's identity from the client side. Alternatively, if a relatively low number of client credentials are stored at the server side, then the process 200 may proceed to transform the authentication challenge using each of the server side client credentials until a match is found with the response from the client side. If the response is identical to the answer, then the process 200 authenticates the client (block 226). Otherwise, the process 200 rejects the client's authentication request (block 228).

The process 200 then repeats as the client browses to another service provided by a server (block 202). If the client halts the single sign-on service, such as by closing a single sign-on service window/interface, then the process 200 removes the client credentials from local storage. Thus, an unauthorized user cannot subsequently use the client's computer to sign-on to services authorized for the client. It also should be noted that the foregoing system 100 and process 200 may operate without any data encryption techniques for data transmissions between remote computers. As described above, the present technique stores the client credentials independently at both the client-side and server-side, thereby improving security and reducing or eliminating the need for transmitting sensitive client data across the network. Instead, the present technique provides secure sign-ons by transmitting only the authentication challenge and the authentication response over the network 14. However, the present technique may transmit a client identifier to the server to facilitate the identification of the appropriate client credentials at the server side. In any case, the present technique improves security and automates the sign-on process for multiple devices and services by requiring only a single entry of the client credentials, by independently retaining the client credentials at both the client-side and the server-side, and by avoiding the transmission of client credentials across the network.

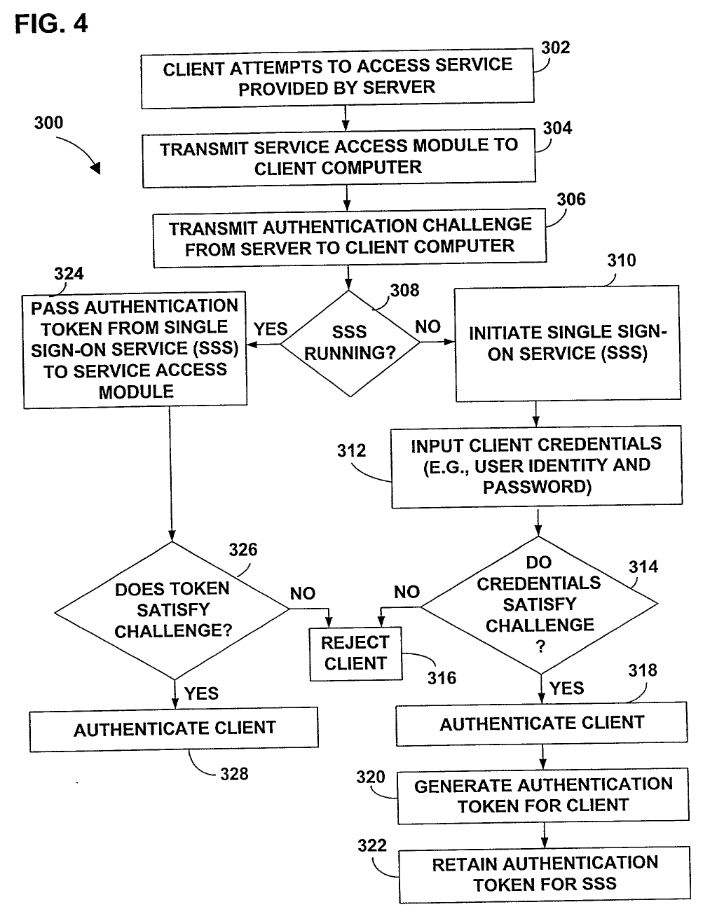

The present technique also may use a variety of other authentication and sign-on systems, which benefit from the single sign-on techniques described above. For example, as illustrated by process 300 of FIG. 4, the present technique may provide a single sign-on mechanism that generates an authentication token for subsequent sign-ons. In this exemplary process 300, the client 102 locates and attempts to access a desired network device or service provided by a server (block 302). The process 300 then transmits a service access module from the server to the client (e.g., to a client Web browser) to initiate a sign-on routine for the desired network device or service (block 304). For example, the service access module may embody a Java applet or a script, such as VBScript, in the web page for the client Web browser. The process 300 also transmits an authentication challenge from the server to the client (block 306). The authentication challenge may embody any suitable secure sign-on challenge, which requires the client to provide a response to gain access to the desired network device or service. In this exemplary sign-on technique, the process 300 then queries whether a single sign-on service (SSS) is already operating on the client (block 308).

If the single sign-on service is not already operating, then the process 300 proceeds to initiate the single sign-on service (block 310). The process 300 then prompts the client 102 to input client credentials, such as a user identity and password, for signing-on to the desired network device or service (block 312). A query 314 then compares the client credentials against the authentication challenge to determine whether the client credentials satisfy the authentication challenge. If the client credentials do not satisfy the authentication challenge, then the process 300 rejects the client's request to sign-on to the desired network device or service (block 316). If the client credentials do satisfy the authentication challenge, then the process 300 authenticates the client 102 and grants the client's request to sign-on to the desired network device or service (block 318). This can be repeated to cover several possible user credentials. For example, the applet could try several possible combinations, probably driven by the server, trying several times until the list of credentials is exhausted. This is particularly useful in the case where some servers have one username and password and other servers have a different combination. The process 300 then proceeds to generate an authentication token for the client 102 for use in subsequent sign-on routines (block 320). The authentication token is then stored at the client 102 for use by the single sign-on service, which automates the sign-on routine for subsequent sign-ons to desired network devices and services (block 322).

Returning to block 308, if the single sign-on service is already operating, then the process 300 passes the authentication token from the single sign-on service to the service access module to automate the authentication of the client 102 (block 324). The process 300 then queries whether the authentication token satisfies the authentication challenge (block 326). If the authentication token does not satisfy the authentication challenge, then the process 300 rejects the client's request to sign-on to the desired network device or service (block 316). If the authentication token does satisfy the authentication challenge, then the process 300 authenticates the client 102 and grants the client's request to sign-on to the desired network device or service (block 328). Accordingly, the single sign-on service automates client authentication for subsequent sign-ons to network devices and services by temporarily or permanently storing client credentials and/or an authentication token.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method for authenticating a client for multiple services on a network, comprising the acts of:
authenticating a client for a first service without transmitting client credentials across the network;
retaining client authentication data associated with the first service at a server and at a client computer for the client; and
automatically authenticating the client for a second service using the client authentication data retained at the client computer.

2. The method of claim 1, wherein the act of authenticating the client comprises the act of securely authenticating the client without using data encryption.

3. The method of claim 1, wherein the act of authenticating the client comprises the act of securely authenticating the client without using a remote directory service.

4. The method of claim 1, wherein the act of authenticating the client comprises the act of securely authenticating the client by performing authentication routines independently at the server and at the client computer using client credentials independently retained at the server and at the client computer.

5. The method of claim 1, wherein the act of authenticating the client comprises the act of prompting the client to input client credentials.

6. The method of claim 5, wherein the act of prompting the client to input client credentials comprises the act of requesting a user identity and a user password from the client.

7. The method of claim 1, wherein the act of authenticating the client comprises the act of generating an authentication token for the client.

8. The method of claim 7, wherein the act of retaining client authentication data comprises the act of locally retaining the authentication token at the client computer.

9. The method of claim 1, wherein the act of retaining client authentication data comprises the act of locally retaining the client credentials at the client computer.

10. The method of claim 1, wherein the act of authenticating the client comprises the acts of:
transmitting an authentication challenge from a desired one of the multiple services to the client in response to an access request from the client; and
computing a response to the authentication challenge at the client computer by transforming the authentication challenge using client credentials obtained at the client computer.

11. The method of claim 10, wherein the act of retaining client authentication data comprises the act of locally retaining the client credentials at the client computer.

12. The method of claim 10, wherein the act of retaining client authentication data comprises the act of locally retaining the response at the client computer.

13. The method of claim 10, wherein the act of authenticating the client comprises the acts of:
computing an answer to the authentication challenge at a server for the first service by transforming the authentication challenge using client credentials stored at the server; and
comparing the response against the answer.

14. The method of claim 13, wherein the act of computing the answer comprises the acts of:
identifying the client; and
retrieving the client credentials for the client from storage at the server.

15. The method of claim 14, wherein the act of authenticating the client comprises the act of transmitting the response and a client identifier from the client computer to the server.

16. The method of claim 13, wherein the act of computing the answer comprises the act of successively transforming the authentication challenge using successive client credentials of a plurality of client credentials stored at the server, and wherein the act of authenticating the client comprises the act of providing an authentication grant only if a match is identified between the response and the answer.

17. The method of claim 1, wherein the act of retaining client authentication data comprises the act of temporarily retaining the client authentication data at the client computer.

18. The method of claim 17, wherein the act of temporarily retaining the client authentication data comprises the act of eliminating the client authentication data from local memory at the client computer upon completion of a service session.

19. The method of claim 1, wherein the act of authenticating the client comprises the act of transmitting an authentication module to a web browser at the client computer.

20. The method of claim 1, wherein the act of retaining client authentication data comprises the act of executing a single sign-on module at the client computer.

21. The method of claim 20, wherein the act of executing the single sign-on program comprises the act of temporarily retaining and providing the client authentication data for automatically authenticating the client for the second service.

22. The method of claim 21, wherein the act of automatically authenticating the client comprises the acts of:
executing an authentication routine by a client web browser; and
automatically passing the client authentication data from the single sign-on module to the authentication routine.

23. A single sign-on method for a client to sign-on to multiple services on a network, comprising the acts of:
transmitting an authentication challenge for a desired service of the multiple services to a client computer in response to an access request;
obtaining client credentials from the client;
computing a response to the authentication challenge using the client credentials at the client computer;
computing an answer to the authentication challenge using client credentials stored at a server for the desired service;
authenticating the client for the desired service if the response satisfies the answer; and
retaining the client credentials at the client computer to authenticate the client for a subsequent desired service of the multiple services.

24. The method of claim 23, wherein the act of authenticating the client comprises the act of securely authenticating the client without transmitting the client credentials over the network.

25. The method of claim 23, wherein the act of authenticating the client comprises the act of securely authenticating the client without encrypting data transmissions between the client computer and the server.

26. The method of claim 23, wherein the act of authenticating the client comprises the act of securely authenticating the client without using a remote directory service.

27. The method of claim 23, comprising the act of generating the authentication challenge comprising a random number.

28. The method of claim 27, wherein the act of computing the response comprises transforming the random number with the client credentials stored at the client computer.

29. The method of claim 27, wherein the act of computing the answer comprises transforming the random number with the client credentials stored at the server.

30. The single sign-on method of claim 23, comprising automatically authenticating the client for the subsequent desired service using the client credentials retained at the client computer.

31. The single sign-on method of claim 23, wherein the act of authenticating the client comprises the act of transmitting an authentication module to a web browser at the client computer.

32. The single sign-on method of claim 23, wherein the act of authenticating the client comprising the act of initiating a single sign-on module at the client computer.

33. The single sign-on method of claim 32, wherein the act of initiating the single sign-on module comprises the act of retaining and providing the client credentials for automatically authenticating the client for the subsequent desired service of the multiple services.

34. The single sign-on method of claim 33, comprising the acts of:
executing an authentication module at the client computer to authenticate the client for the subsequent desired service of the multiple services; and
automatically passing the client credentials retained for the single sign-on module from the single sign-on module to the authentication module.

35. The single sign-on method of claim 23, wherein the act of computing the answer comprises the acts of:
identifying the client using a client identifier received from the client computer; and
retrieving the client credentials for the client from storage at the server.

36. The single sign-on method of claim 23, wherein the act of computing the answer comprises the act of successively transforming the authentication challenge using successive client credentials of a plurality of client credentials stored at the server, and wherein the act of authenticating the client comprises the act of providing an authentication grant only if a match is identified between the response and the answer.

37. The single sign-on method of claim 23, wherein the act of computing the response comprises the act of transforming the authentication challenge using an authentication token and the client credentials at the client computer.

38. The single sign-on method of claim 23, wherein the act of computing the response comprises the act of transforming the authentication challenge using a smart card and the client credentials at the client computer.

39. The single sign-on method of claim 23, wherein the acts of computing the response and computing the answer comprise the act of transforming the authentication challenge independently at the client computer and the server using private and public keys and the client credentials.

40. A computer system comprising a plurality of networked computing devices, comprising:
a network;
a client computer operably coupled to the network;
a plurality of servers operably coupled to the network;
a plurality of services disposed on the servers and accessible by the client computer via the network;
a secure client authentication system having authentication routines independently executable at the client computer and at the server;
a database of client credentials accessible by a server-side routine of the authentication routines; and
a single sign-on service comprising a data retention module to retain client credentials obtained at the client computer and an automatic sign-on module to pass the client credentials to a client-side routine of the authentication routines.

41. The computer system of claim 40, wherein the authentication routines each comprise response computation modules adapted to compute independent transformations of a random authentication challenge using the client credentials independently accessible by the client computer and the server.

42. The computer system of claim 41, wherein the secure client authentication system comprises a comparison module adapted to compare the independent transformations.

43. The computer system of claim 40, wherein the secure client authentication system is operable without data encryption.

44. The computer system of claim 40, wherein the secure client authentication system is operable without a remote directory service.

45. The computer system of claim 40, wherein the secure client authentication system is operable without transmitting client credentials across the network.

46. The computer system of claim 40, wherein the secure client authentication system is a challenge-response authentication system, which depends on independent instances of the client credentials at the client computer and at the server.

47. The computer system of claim 40, wherein the single sign-on service automates the client-side routine for automatically signing the client onto subsequent services of the plurality of services after the secure client authentication system has authenticated the client for a first service of the plurality of services.

48. The computer system of claim 40, wherein the secure client authentication system comprises a security set of public and private keys.

49. The computer system of claim 48, wherein the secure client authentication system comprises a smart card accessible at the client computer.

50. A server comprising a service accessible by a client computer via a network, comprising:
a single sign-on service for a secure client authentication system that depends on independent instances of client credentials at a server-side and at a client-side of the network to authenticate a client for a desired service without transmitting the client credentials across the network, the single sign-on service comprising:
a data retention module that locally retains client credentials obtained locally from the client for the secure client authentication system; and
a data exchange module that automatically passes the client credentials retained by the data retention module to the secure client authentication system.

51. The server of claim 50, wherein the secure client authentication system comprises a response computation module adapted to transform a random authentication challenge independently at the client computer and at the server using the client credentials independently accessible by the client computer and the server.

52. The server of claim 50, wherein the secure client authentication system is operable without data encryption.

53. The server of claim 50, wherein the secure client authentication system is operable without a remote directory service.

54. The server of claim 50, wherein the data exchange module comprises an authentication interaction module to identify an authentication challenge from the desired service and to provide the client credentials locally for the authentication challenge if the data retention module previously retained the client credentials for another authentication challenge.

55. A single sign-on service module comprising:
an interaction module that identifies an authentication challenge from a secure client authentication system, which depends on independent instances of client credentials at a server side and at a client side of the network to authenticate a client for a desired service without transmitting the client credentials across the network;
a data retention module that locally retains client credentials obtained locally from the client for the secure client authentication system; and
a data exchange module that automatically passes the client credentials retained by the data retention module to the secure client authentication system.

56. The single sign-on service module of claim 55, wherein the interaction module executes the data exchange module to provide the client credentials locally for the authentication challenge if the data retention module previously retained the client credentials for another authentication challenge.

57. The single sign-on service module of claim 55, wherein the interaction module, the data retention module, and the data exchange module are executable by a web browser.

58. A method for signing onto multiple services on a network, comprising the acts of:
locating a first service on the network;
receiving a first authentication challenge from a client authentication system for the first service;
inputting client credentials into a client computer in response to the first authentication challenge;
gaining access to the first service if the client authentication system for the first service authenticates the client against a database of client credentials remote from the client computer without transmitting the client credentials across the network;
retaining the client credentials at the client computer;
locating a second service on the network;
receiving a second authentication challenge from a client authentication system for the second service;
automatically providing the client credentials for the second authentication challenge; and
gaining access to the second service if the client authentication system for the second service authenticates the client against a database of client credentials remote from the client computer without transmitting the client credentials across the network.

59. The method of claim 58, wherein the acts of gaining access to the first and second services comprise the act of transmitting authentication data across the network without data encryption or directory services.

60. The method of claim 58, wherein the act of gaining access to the first service comprises the act of obtaining an authentication token for the second authentication challenge.

61. The method of claim 60, wherein the act of retaining the client credentials comprises the act of retaining the authentication token.

62. The method of claim 61, wherein the act of automatically providing the client credentials comprises automatically transmitting the authentication token to satisfy the second authentication challenge for the second service.

63. A method for authenticating a client for multiple services on a network, comprising the acts of:
receiving an authentication challenge from a client authentication system for a service desired by the client at a client computer;
prompting the client to input client credentials at the client computer in response to the authentication challenge;
transmitting an authentication response devoid of the client credentials to the client authentication system for comparison against an authentication answer derived from the authentication challenge and client credentials retained independently from the client computer;
receiving an authentication grant from the client authentication system if the authentication response satisfies the authentication answer;
retaining the client credentials at the client computer; and
automatically providing the client credentials for a subsequent authentication challenge received at the client computer to authenticate the client automatically for a subsequent service.

64. The method of claim 63, wherein the act of transmitting the authentication response is performed without data encryption.

65. The method of claim 63, wherein the act of receiving an authentication grant comprises the act of obtaining an authentication token for the subsequent authentication challenge.

66. The method of claim 65, wherein the act of retaining the client credentials comprises the act of retaining the authentication token.

67. A method for authenticating a client for multiple services on a network, comprising the acts of:
transmitting an authentication challenge for a service desired by the client from a server to a client computer;
querying whether client credentials are retained at the client computer;
prompting the client to input client credentials if not retained at the client computer;
prompting the client computer to access client credentials at the client computer if client credentials are present at the client computer;
independently transforming the authentication challenge at the client computer and at the server using the client credentials accessible at the client computer and at the server;
transmitting authentication data derived from one of the foregoing transformations over the network; and
authenticating the client if the foregoing transformations produce equivalent authentication data.

68. The method of claim 67, wherein the act of transmitting the authentication data is performed without data encryption.

69. The method of claim 67, wherein the act of authenticating the client comprises the act of transmitting an authentication token to the client computer for subsequent authentication challenges.

70. The method of claim 67, wherein the act of independently transforming the authentication challenge comprises the act of using an authentication token.

71. The method of claim 70, wherein the act of independently transforming the authentication challenge comprises the act of accessing a smart card.

72. The method of claim 67, wherein the act of independently transforming the authentication challenge comprises the act of using public and private keys.
